(19) United States
(12) Patent Application Publication
(10) Pub. No.: US 2013/0311936 A1
(43) Pub. Date: Nov. 21, 2013

(54) CONTEXTUAL RENDERING IN DISPLAYING OBJECTS

(71) Applicant: SERIOUS INTEGRATED, INC., Chandler, AZ (US)

(72) Inventors: Gregg Donald Lahti, Gilbert, AZ (US); Terry David West, Chandler, AZ (US); Mark Jon Koch, Las Vegas, NV (US)

(73) Assignee: SERIOUS INTEGRATED, INC., Chandler, AZ (US)

(21) Appl. No.: 13/799,080

(22) Filed: Mar. 13, 2013

Related U.S. Application Data
(60) Provisional application No. 61/647,228, filed on May 15, 2012.

(51) Int. Cl. G06F 3/0481

(52) U.S. Cl. CPC G06F 3/0481
USPC 715/781

(57) ABSTRACT

Methods, systems and computer-readable media for digital content creation by contextually rendering objects utilizing an object hierarchy for manipulation are disclosed. A Graphical User Interface (GUI) is presented in a window and includes a hierarchical representation of digital objects for potential placement in a rendering window. The user can select a first digital object that is present in the rendering window and select a rendering option for the first digital object. In response to the selection of the rendering option, all of the digital objects in the hierarchical representation that are present in the rendering window are de-emphasize in the rendering window except the first digital object.

### CROSS-REFERENCE TO RELATED APPLICATIONS

This application claims priority to U.S. Provisional Patent Application Ser. No. 61/647,228, filed May 15, 2012, the disclosure of which is hereby incorporated by reference in its entirety.

### TECHNICAL FIELD

Embodiments of the present disclosure relate generally to Graphical User Interfaces (GUIs), and more specifically to rendering objects in the GUI.

### BACKGROUND

All patents, patent applications, and publications referred to or cited herein, are hereby incorporated by reference in their entirety.

### Background

GUIs for developing digital content such as presentation slides, digital documents or digital imaging use drawing, click and select methods to create items on the digital page. For example, in Powerpoint, the user can add boxes, circles and text to a page in order to create an image to present. Another example would be creating a marketing document using Adobe tools such as Fireworks or InDesign which enables easy manipulation of graphics and images in addition to text. In many instances of drawing the digital content, items need to overlap to produce a layered effect for imaging, as in the case of alpha-blended backgrounds with foreground images, or in animation of items being presented on the area. Many of these software based tools to create digital content have a unique method for manipulating text and graphical images. However, a drawback of these programs is the ability to manipulate multiple overlapping images in an easy and concise manner, especially when several of these images overlap each other like a sandwich. Some graphical content creation programs, such as Powerpoint, do not allow easy selection of say the middle layer of a three-layer image stack for editing or manipulating, especially when doing customized animations. Other software programs, such as Adobe-based design tools, use a separate method of “layers” to manipulate the image but do not allow the user to handle hierarchical trees of information. Currently, the state of the art of graphic content tools widely used today do not have the ability to handle multiple hierarchies of data, visually represent all items on the area in the hierarchy as a layered stack and have the ability to select the n-layer item and edit it without disturbing the other layers.

### BRIEF DESCRIPTION OF THE DRAWINGS

FIG. 1 illustrates a computing system for practicing embodiments of the present disclosure.

FIG. 2 is an example of a software application tool showing a hierarchal representation and a rendering area for practicing embodiments of the present disclosure.

FIG. 3 shows a method of selecting a rendering context in a state flow diagram.

FIG. 4 shows a hierarchal method of objects utilized within a sample application.

FIG. 5 also shows an outcome of selecting a “Render Context” option.

FIGS. 6, 7, 8, 9, and 10 show examples of rendering objects and objects-within-objects.

### DETAILED DESCRIPTION

In the following description, reference is made to the accompanying drawings in which is shown, by way of illustration, specific embodiments in which the disclosure may be practiced. The embodiments are intended to describe aspects of the disclosure in sufficient detail to enable those skilled in the art to practice the invention. Other embodiments may be utilized and changes may be made to the disclosed embodiments without departing from the scope of the disclosure. The following detailed description is not to be taken in a limiting sense, and the scope of the present invention is defined only by the appended claims.

Furthermore, specific implementations shown and described are only examples and should not be construed as the only way to implement the present disclosure unless specified otherwise herein. It will be readily apparent to one of ordinary skill in the art that the various embodiments of the present disclosure may be practiced by numerous other partitioning solutions.

In the following description, elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, symbols, and chips that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor is configured to execute instructions (e.g., software code) related to embodiments of the present disclosure. A processor may also be implemented as a combination of computing devices, such as a combination of a DSP and a microprocessor, a plurality of microprocessors, one or more microprocessors in conjunction with a DSP core, or any other such configuration.

Also, it is noted that the embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

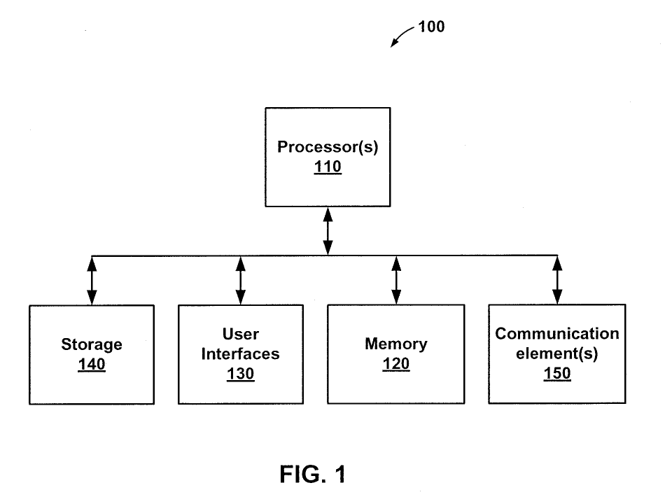

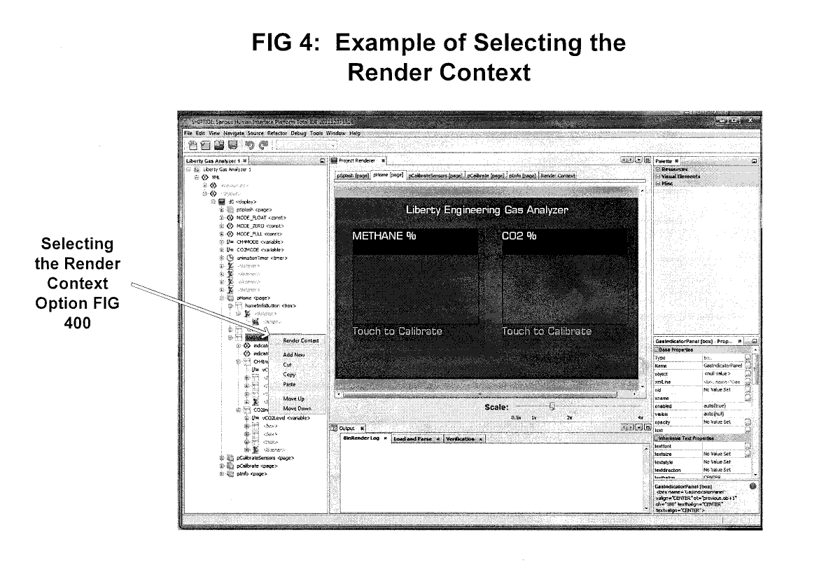

Elements described herein may include multiple instances of the same element. These elements may be generically indicated by a numerical designator (e.g. 110) and specifically indicated by the numerical indicator followed by an alphabetic designator (e.g., 110A) or a numeric indicator preceded by a “dash” (e.g., 110-1). For ease of following the description, for the most part element number indicators begin with the number of the drawing on which the elements are introduced or most fully discussed. Thus, for example, element identifiers on a FIG. 1 will be mostly in the numerical format 1xx and elements on a FIG. 4 will be mostly in the numerical format 4xx.

Headings are included herein to aid in locating certain sections of detailed description. These headings should not be considered to limit the scope of the concepts described under any specific heading. Furthermore, concepts described in any specific heading are generally applicable in other sections throughout the entire specification.

Conventional presentation-type software can be cumbersome when handling multiple hierarchies of elements, where each element represented a piece of graphical information to be displayed on the given page or area. Each element, such as a piece of text or graphical image, could have sub-elements associated with that element. The user needs the ability to edit or manipulate each of these items on the page visually with or without other items being displayed.

Embodiments of the present disclosure include apparatuses and methods for contextual rendering of objects at various levels of hierarchy to enable viewing, editing, manipulation, or combinations thereof of selected objects.

FIG. 1 illustrates a computing system 100 for practicing embodiments of the present disclosure. The computing system 100 may be a user-type computer, a file server, a compute server, or other similar computer. Computer, computing system, and server may be used interchangeably herein to indicate a system for practicing embodiments of the present disclosure. The computing system 100 is configured for executing software programs containing computing instructions and includes one or more processors 110, memory 120, one or more communication elements 150, user interface elements 130, and storage 140.

As non-limiting examples, the computing system 100 may be a user-type computer, a file server, a compute server, a notebook computer, a tablet, a handheld device, a mobile device, or other similar computer system for executing software.

The one or more processors 110 may be configured for executing a wide variety of operating systems and applications including the computing instructions for carrying out embodiments of the present disclosure.

The memory 120 may be used to hold computing instructions, data, and other information for performing a wide variety of tasks including performing embodiments of the present disclosure. By way of example, and not limitation, the memory 120 may include Synchronous Random Access Memory (SRAM), Dynamic RAM (DRAM), Read-Only Memory (ROM), Flash memory, and the like.

Information related to the computing system 100 may be presented to, and received from, a user with one or more user interface elements. As non-limiting examples, the user interface elements may include elements such as displays, keyboards, mice, joysticks, haptic devices, microphones, speakers, cameras, and touchscreens. A display on the computing system may be configured to present a graphical user interface (GUI) with information about the embodiments of the present disclosure, as is explained below.

The communication elements 150 may be configured for communicating with other devices or communication networks. As non-limiting examples, the communication elements 150 may include elements for communicating on wired and wireless communication media, such as for example, serial ports, parallel ports, Ethernet connections, universal serial bus (USB) connections IEEE 1394 (“firewire”) connections, Bluetooth wireless connections, 802.1 a/b/g/n type wireless connections, and other suitable communication interfaces and protocols.

The storage 140 may be used for storing relatively large amounts of non-volatile information for use in the computing system 100 and may be configured as one or more storage devices. By way of example, and not limitation, these storage devices may include computer-readable media (CRM). This CRM may include, but is not limited to, magnetic and optical storage devices such as disk drives, magnetic tapes, CDs (compact disks), DVDs (digital versatile discs or digital video discs), and other equivalent storage devices.

Software processes illustrated herein are intended to illustrate representative processes that may be performed by the systems illustrated herein. Unless specified otherwise, the order in which the process acts are described is not intended to be construed as a limitation, and acts described as occurring sequentially may occur in a different sequence, or in one or more parallel process streams. It will be appreciated by those of ordinary skill in the art that many steps and processes may occur in addition to those outlined in flow charts. Furthermore, the processes may be implemented in any suitable hardware, software, firmware, or combinations thereof.

When executed as firmware or software, the instructions for performing the processes may be stored on a computer-readable medium. A computer-readable medium includes, but is not limited to, magnetic and optical storage devices such as disk drives, magnetic tape, CDs (compact disks), DVDs (digital versatile discs or digital video discs), and semiconductor devices such as RAM, DRAM, ROM, EPROM, and Flash memory.

By way of non-limiting example, computing instructions for performing the processes may be stored on the storage 140, transferred to the memory 120 for execution, and executed by the processors 110. The processors 110, when executing computing instructions configured for performing the processes, constitutes structure for performing the processes and can be considered a special-purpose computer when so configured. In addition, some or all portions of the processes may be performed by hardware specifically configured for carrying out the processes.

Using a computing system 100 with a graphical operating system, embodiments of the present disclosure include software application tools providing functional panels or windows within the application to segment the functionality. Many panels can be used to describe multiple functions but in this description two of the panels will be presented to the user which control and display the items being utilized within the application tool. The application tool is used to create digital content for various products of which one element could be to generate a GUI (Graphical User Interface) to run on a computing system 100 utilizing an LCD touch/display screen. In this application tool, the user provides graphical data in the form of images, pictures, and text to create a digital content output. The digital content output could be represented on a computer screen or hardware screen or output to paper.

Thus, in some embodiments, the digital content output may be created on one computing system 100, such as, for example, a personal computer or workstations, but is intended for presentation on another computing system 100, such as, for example, an embedded control application with one or more displays, which may also be touch-screen type displays. As a result, accurate representation of what may be seen on this other intended target may be desired.

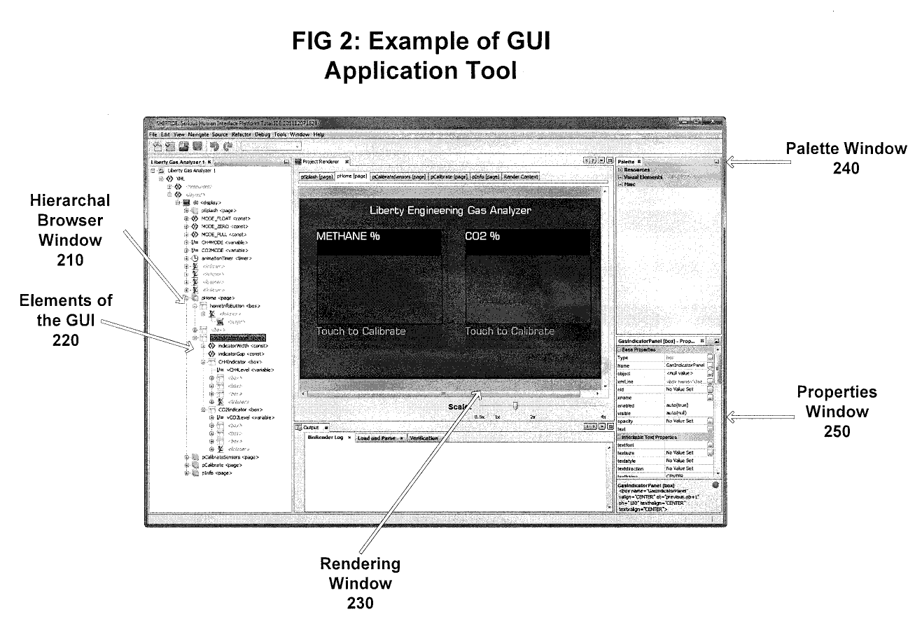

The application tool as shown in FIG. 2 provides the user the ability to manipulate the objects (images, pictures, fonts, text, actions, etc) on the screen in a WYSIWYG (What You See Is What You Get) format where the user sees the output on a main rendering area. This main rendering area may be contained as a sub-window or sub-panel within the application tool. The application tool will render the user's objects as how the user has placed them much like placing items on top of each other or near each other.

The application tool may also utilize another method to organize the objects. This method of organization may be represented as a sub-panel or sub-window within the application tool. The application tool uses this area to present the objects being utilized within the application to the user in a hierarchal representation. In one embodiment, FIG. 2 shows an example of a GUI application tool that is broken up into sub-windows which divide the functionality. A hierarchal browser 210 sub-window (may also be referred to herein as a hierarchical representation) shows the hierarchy of various objects used within a project as represented by various digital objects 220 that may be selected. A rendering window 230 shows what the project would be rendered visually in a WYSIWYG format. A palette window 240 may be displayed to provide contextual objects for editing or utilizing within the project and a properties window 250 may be included to show the detailed elements that make up the selected object.

Within the hierarchal representation 210, the application tool represents the digital objects 220 of information in a tree-style, hierarchical format. Any given digital object 220 can be a child or parent object depending upon its place within the hierarchy. Each digital object 220 may represent a piece of information used in the content creation and details of that object get presented in the properties window 250. As non-limiting examples, these objects may be an image or piece of text or a potential operation or action within the tool. Each object item may have multiple sub-objects within the element hierarchy. In one embodiment, this hierarchy tree can be described using XML (Extensible Markup Language) to fully define the rules of encoding.

In the application tool, these digital objects 220 may be presented to the user in a layered effect on the main rendering window 230 in a WYSIWYG format for editing purposes. This presentation enables the user to see the full effect of putting the objects in various positions in the main rendering window 230, possibly covering or hiding other objects.

In embodiments of the present disclosure, objects that may be used in the main rendering window 230 are arranged in a hierarchy tree of parent, siblings, and children and are presented to the user and then selected by the user for manipulation as shown in the hierarchical representation 210. As a non-limiting example, an XML-defined hierarchy tree for navigation of the objects is presented to the user as shown in FIG. 1 and the rendering window for the WYSIWYG results in FIG. 2. When the user wants to edit an object within the hierarchy, all the user needs to do is “select” the item and use a sub-menu option to “context render” the object.

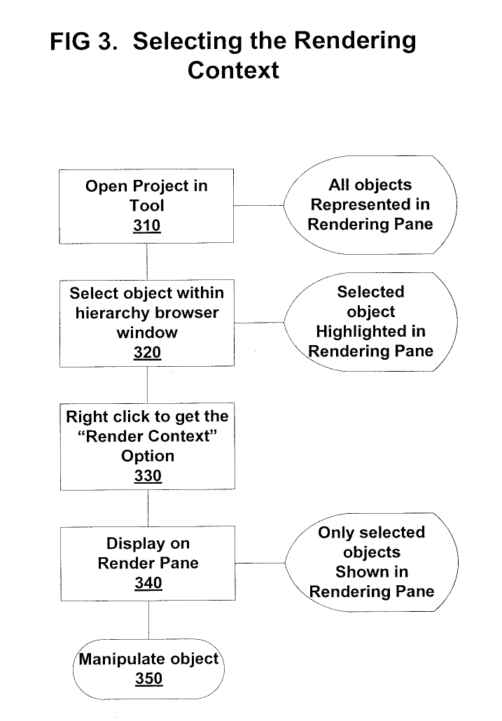

The actions of this method are shown in FIG. 3 as a flowchart where operation block 310 indicates that the user opens the project. Operation block 320 indicates that the user then selects the object within the hierarchy browser 320. As a non-limiting example, operation block 330 indicates that a right-click by the user brings up a context-sensitive menu which shows the “Render Context” option. Once the user selects the “Render Context” option, operation block 340 indicates the new image may be displayed on the rendering window 230 as a sub-window by itself, or within the original rendering window 230. This operation shows the object selected and presents the object on the rendering area to the user with the other items de-emphasized, enabling access to manipulate that object specifically. Operation block 350 indicates that the user can then manipulate or modify that particular object, such as change the font type, the color of the image or replace the image altogether without altering other objects on the rendering area.

In FIG. 4 an example of a pop-up window 400 enabled by a right-click of the mouse to show a context-sensitive menu for selecting the “Render Context” option. A pop-up window invoked with a right click of the mouse is one possible way to present the render context for selection. However, the render context option may be selected in other ways, such as, for example, entering a function key, entering other shortcut keys, or combination of keys when the desired digital object is selected, or double-clicking on the digital object. In addition, in some embodiments, it may be possible to select the digital object in the rendering window 230 rather than selecting it in the hierarchical representation.

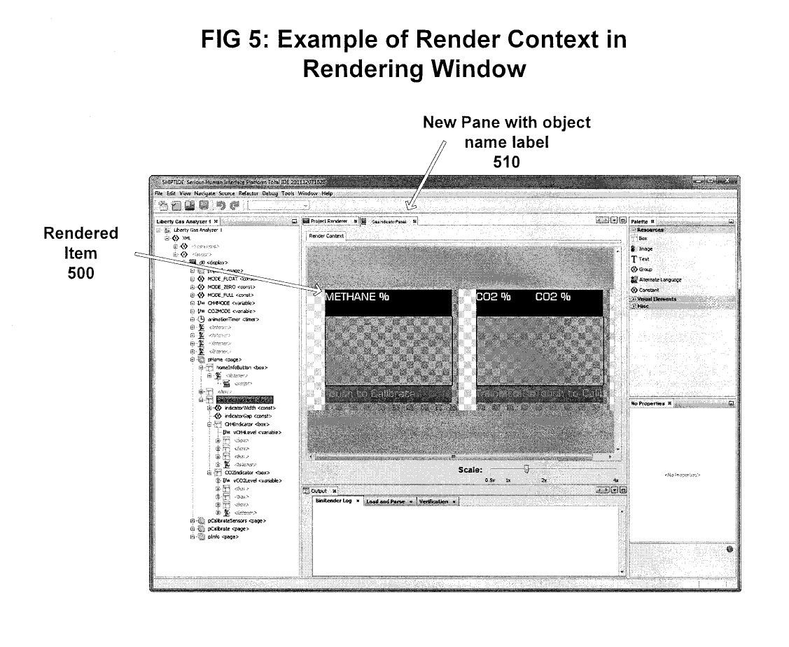

In FIG. 5 shows an example result of selecting the GasIndicatorPanel object to be rendered as a “Render Context” action item, where the selected image is rendered in the rendering window 500 and a new browser tab gets added 510. The user can also move the object within the hierarchy (i.e. promoting up or down the hierarchy) or even simply delete it. When the user is done, the user then can select the re-draw area function to see the fully WYSIWYG drawing which would incorporate the entire hierarchy all of the images. By using the Contextual Rendering Method, the user can optimally select within the hierarchy of objects the exact object and see it “live” without disturbing the placing or formatting of the other objects. In the embodiment, the other objects are not shown but could also be deselected and given the illusion of not selected by rendering or display those images in a dim fashion, a gray fashion or change the opacity of each object to be part of the background image such that the user can easily determine that the non-selected objects are not the focus of the object that is selected.

When selecting objects from the hierarchy browser window 210, the user could optionally also select multiple objects in addition to a single object to show the total aggregated selected objects in the rendering area.

The GUI application tool may potentially show any animation or actions utilizing objects selected for context rendering in the rendering window 230.

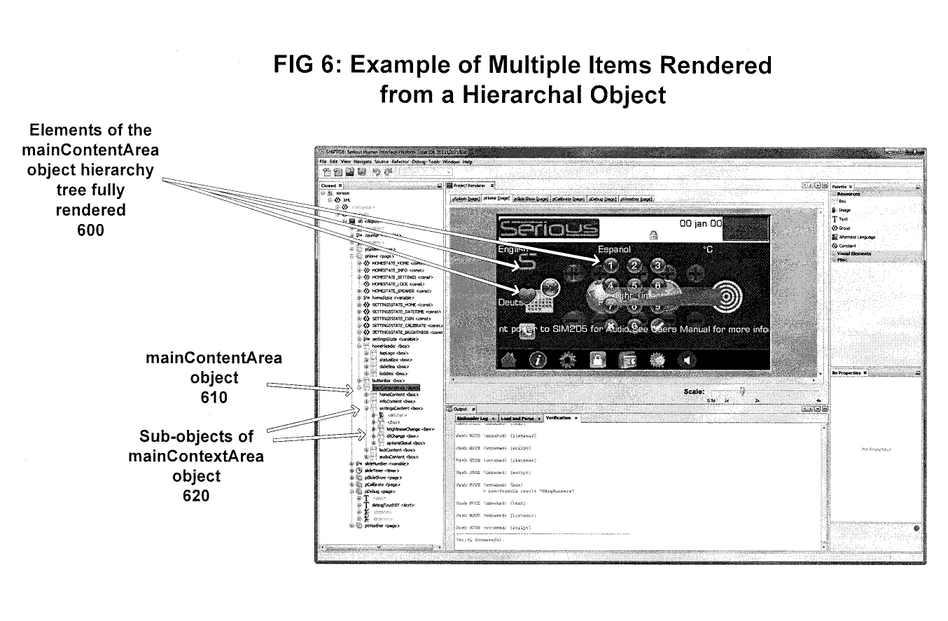

An example of the embodiment showing multiple objects rendered using Context Render option is shown in FIG. 6. In 600, the entire project object tree is shown in Rendering Window 600. The object 610 object named mainContentArea is a box object with several other box objects as children objects 620.

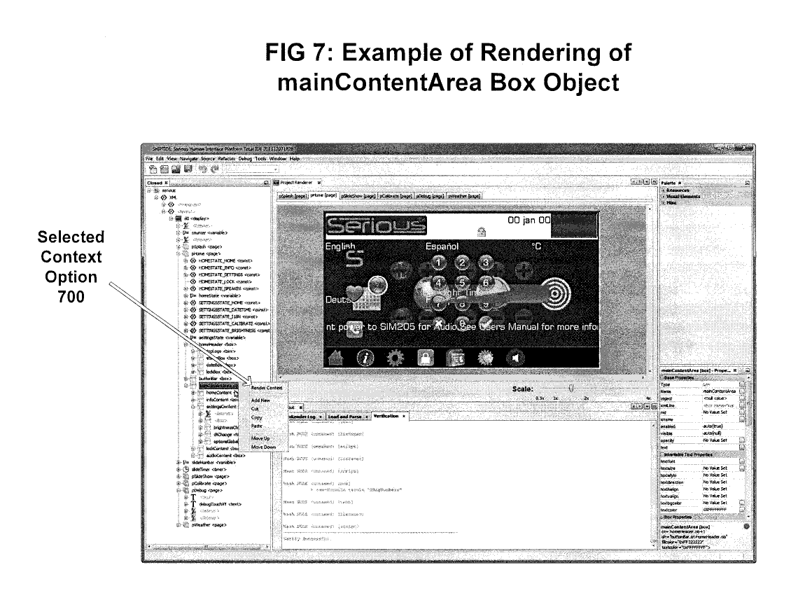

FIG. 7 shows an example of selecting the mainContentArea object 610 and right-clicking to achieve the menu to select the Render Context option 700.

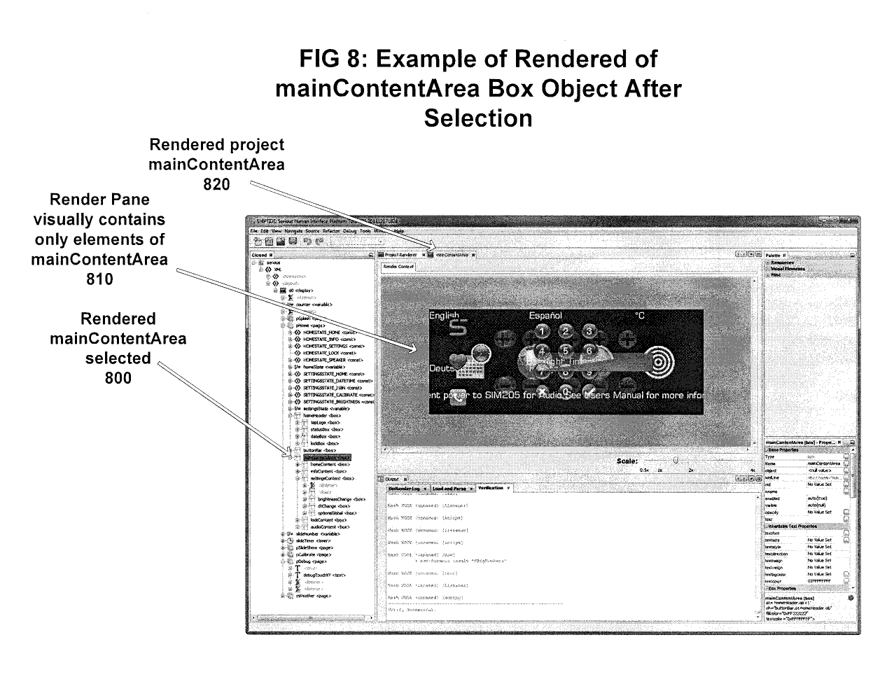

FIG. 8 shows an example of the outcome of the Render Context option of the mainContentArea object 800 selected where now the object mainContentArea object 800 and the children objects are displayed in the Render Context window 810 and that the other objects not associated with the mainContentArea object 800 and the children objects are not displayed. The Render Context window gets a tabbed element with the mainContentArea name 820 showing that this is a representation of the mainContentArea object 800.

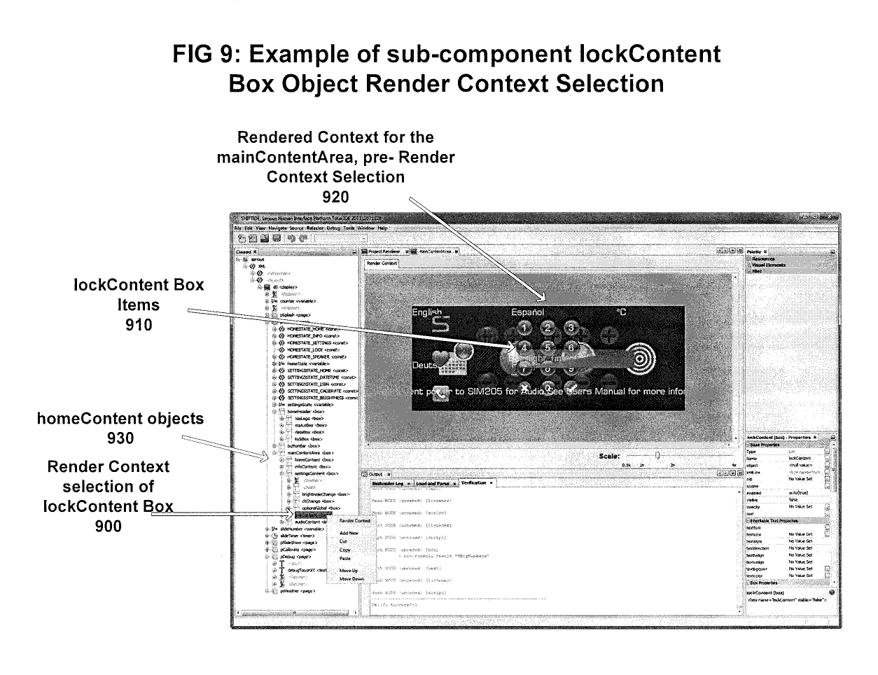

FIG. 9 shows an example of a lockContentBox object 900 which is a sub-object of the mainContentArea object 800. This object in this example is a keypad object showing numerals 0 through 9, an X and a checkbox in a telephone fashion. This example could be of any object or graphic used to signify a system. The lockContentBox 900 example is shown where other objects within the mainContentArea object 800 are layered on top and below the lockContentBox object 900 such as homeContent objects 930. In order to select the lockContentBox object 900, the user would select the object and use the Render Context option to edit that object specifically. To demonstrate this function, FIG. 9 shows the lockContext object 900 selected and the right-click option used to enable the context menu for the Render Context option.

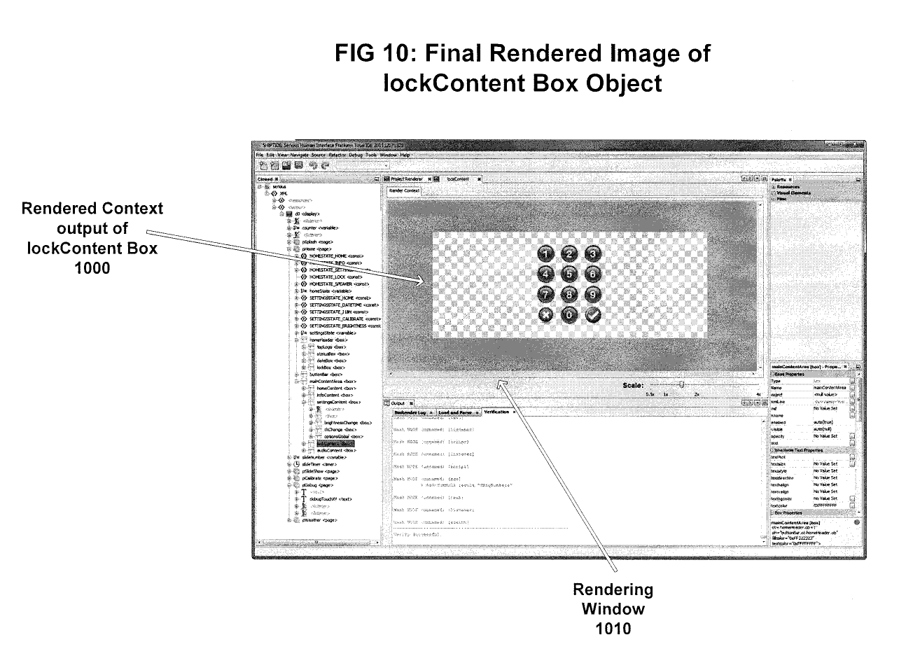

FIG. 10 shows the final rendered context output 1000 of just the lockContent box object selected with other objects de-emphasized in the rendering window 1010. In this case, the other objects are not shown as a way to de-emphasized them.

While the invention is susceptible to various modifications and implementation in alternative forms, specific embodiments have been shown by way of examples in the drawings and have been described in detail herein. However, it should be understood that the invention is not intended to be limited to the particular forms disclosed. Rather, the invention includes all modifications, equivalents, and alternatives falling within the scope of the following appended claims and their legal equivalents.

What is claimed is:

1. A computer-implemented method of presenting information to a user in a Graphical User Interface (GUI), comprising:
presenting a rendering window in the GUI;
presenting a hierarchical representation of a plurality of digital objects for potential placement in the rendering window;
selecting a first digital object of the plurality of digital objects present in the rendering window;
selecting a rendering option for the first digital object;
de-emphasizing all the plurality of digital objects in the rendering window except the first digital object responsive to the rendering option selected.

2. The method of claim 1, further comprising enabling the first digital object for editing responsive to the rendering option selected.

3. The computer-implemented method of claim 1, wherein selecting the rendering option generates a new rendering window and de-emphasizing all the plurality of digital objects in the rendering window except the first digital object occurs in the new rendering window.

4. The computer-implemented method of claim 1, wherein:
selecting the first digital object comprises selecting the first digital object in one or more of the rendering window and the hierarchical representation; and
selecting the rendering option comprises invoking a popup window including the rendering option for selection.

5. The computer-implemented method of claim 1, wherein the plurality of digital objects is selected from the group consisting of pictures, images, text, graphics, and animations.

6. The computer-implemented method of claim 1, wherein presenting the rendering window further comprises presenting a window in a :What You See Is What You Get (WYSIWYG) representation showing an intended outcome for an intended presentation window.

7. The computer-implemented method of claim 6, wherein the intended presentation window comprises first graphical parameters different from second graphical parameters of a system performing the method of presenting information.

8. A computing system for presenting information to a user in a Graphical User Interface (GUI), comprising:
a memory configured for storing computing instructions; and
a processor operably coupled to the computing system and configured for executing the computing instructions to:
present a rendering window in the GUI;
present a hierarchical representation of a plurality of digital objects for potential placement in the rendering window;
select a first digital object of the plurality of digital objects present in the rendering window;
select a rendering option for the first digital object;
de-emphasize all the plurality of digital objects in the rendering window except the first digital object responsive to the rendering option selected.

9. The computing system of claim 8, wherein the processor is further configured for executing the computing instruction to enable the first digital object for editing responsive to the rendering option selected.

10. The computing system of claim 8, wherein the processor is further configured for executing the computing instruction to select the rendering option generates a new rendering window and de-emphasizing all the plurality of digital objects in the rendering window except the first digital object occurs in the new rendering window.

11. The computing system of claim 8, wherein the processor is further configured for executing the computing instruction to:
select the first digital object comprises selecting the first digital object in one or more of the rendering window and the hierarchical representation; and
select the rendering option comprises invoking a popup window including the rendering option for selection.

12. The computing system of claim 8, wherein the processor is further configured for executing the computing instruction to select the plurality of digital objects from the group consisting of pictures, images, text, graphics, and animations.

13. The computing system of claim 8, wherein presenting the rendering window further comprises computing instruction for execution by the processor to present a window in a :What You See Is What You Get (WYSIWYG) representation showing an intended outcome for an intended presentation window.

14. The computing system of claim 13, wherein the intended presentation window comprises first graphical parameters different from second graphical parameters of a system performing the method of presenting information.

15. Computer-readable media including computer executable instructions, which when executed on a processor, comprising:
present a rendering window in the GUI;
present a hierarchical representation of a plurality of digital objects for potential placement in the rendering window;
select a first digital object of the plurality of digital objects present in the rendering window;
select a rendering option for the first digital object;
de-emphasize all the plurality of digital objects in the rendering window except the first digital object responsive to the rendering option selected.

16. The computer-readable media of claim 15, further comprising computer executable instructions, which when executed on a processor enable the first digital object for editing responsive to the rendering option selected.

17. The computer-readable media of claim 15, further comprising computer executable instructions, which when executed on a processor select the rendering option generates a new rendering window and de-emphasizing all the plurality of digital objects in the rendering window except the first digital object occurs in the new rendering window.

18. The computer-readable media of claim 15, further comprising computer executable instructions, which when executed on a processor:
select the first digital object comprises selecting the first digital object in one or more of the rendering window and the hierarchical representation; and
select the rendering option comprises invoking a popup window including the rendering option for selection.

19. The computer-readable media of claim 15, further comprising computer executable instructions, which when executed on a processor present the rendering window further comprises presenting a window in a :What You See Is What You Get (WYSIWYG) representation showing an intended outcome for an intended presentation window.

20. The computer-readable media of claim 19, wherein the intended presentation window comprises first graphical parameters different from second graphical parameters of a system performing the method of presenting information.
